(19) United States
(12) Patent Application Publication
(10) Pub. No.: US 2009/0071904 A1
(43) Pub. Date: Mar. 19, 2009

(54) Membrane cover having a protective layer to prevent deterioration of UV stabilizers therein

(75) Inventors: Claude J. Degarie, Fredericton (CA); Sylvain Dufresne-Nappert, Callander (CA)

Correspondence Address: MARIO D. THERIAULT, 812 HWY. 101 NASONWORTH, FREDERICTON, NB, E3C 2B5, CA

(73) Assignee: Geomembrane Technologies Inc.

(21) Appl. No.: 12/292,589

(22) Filed: Nov. 21, 2008

Related U.S. Application Data
(62) Division of application No. 11/099,792, filed on Apr. 6, 2005.

(51) Int. Cl. C02F 1/44

(52) U.S. Cl. 210/650

(57) ABSTRACT

The membrane structure according to the present invention has a top layer containing three plies. The top ply has UV stabilizers embedded therein; the bottom ply has stretch-resistant elements embedded therein; and the middle ply contains a co-extruded polyvinylidene chloride barrier film for example, for protecting the top ply against bio-gas infiltrations therein. In another aspect, the top and bottom plies containing polyethylene for protecting the middle ply from the weather and from corrosive environments under the membrane cover. In yet another aspect, the membrane structure has two foam layers affixed to the bottom ply. Each foam layer is made of juxtaposed strips of semi-rigid, closed-cell, polyethylene foam; wherein each strip in one foam layer is laid astride the adjoining edges of a pair of strips in the other foam layer. The strips of foam are bonded together and to the undersurface of the bottom ply by strips of fused polyethylene.

This is a divisional application of application Ser. No. 11/099,792, filed Apr. 6, 2005

### FIELD OF THE INVENTION

This invention pertains to membrane covers for industrial, municipal and agricultural reservoirs and lagoons, and more particularly, it pertains to a floating membrane cover having a top layer, UV stabilizers in the top layer, a structural layer in contact with the liquid surface of a reservoir and a bio-gas-impermeable shield laid between the top layer and the structural layer.

### BACKGROUND OF THE INVENTION

It has been noted that the useful life of a membrane cover covering a wastewater reservoir in a warm-weather region where the cover is exposed to much sunlight, is somewhat reduced as compared to covers installed in colder climates. After analysing several installations of different ages and in different environmental conditions, it was understood that the porosity of a membrane cover increases with temperature and that the bio-gases generated under a membrane cover slowly seep or migrate upward through the membrane layers and react with the metal oxides forming the essence of the UV stabilizers in the top layer. As these metal oxides are modified or corroded, the UV protection is lost and the life of the membrane cover is proportionally reduced.

Although the materials used in the fabrication of membrane covers of the prior art are considered to be generally impermeable to fluids, the word “impermeable” is a relative term that is used to express a property that can differ from one material to another, and from one condition of use to another. It is also known that certain bio-gases or biological agent vapors have very small molecules that can seep through relatively dense materials.

It is believed that the problem of deterioration of UV stabilizers in a membrane cover has not been addressed in the prior art. As such it is believed that a need exists for an improved membrane structure capable of better preventing a degradation of the UV stabilizers therein.

### SUMMARY OF THE INVENTION

In the present invention, however, there is provided a membrane structure having a top layer with UV stabilizers embedded therein, and a bio-gas shield laid beneath the top layer for preventing the migration of bio-gases into the top layer.

More particularly, the present invention consists of a membrane structure wherein the top layer is made of three plies. The top ply has UV stabilizers embedded therein; the bottom ply has stretch-resistant elements embedded therein; and the middle ply is a bio-gas shield for protecting the top ply against bio-gas infiltration in the top ply.

In this arrangement, the bottom ply has a first impermeability to bio-gases, wherein this first impermeability to bio-gases is comparable to the properties of membrane covers of the prior art. The middle ply has a second impermeability to bio-gases, and the second impermeability to bio-gases has a greater extent than the impermeability of the bottom ply. Preferably the impermeability to bio-gases of the middle ply is twice as much as the impermeability to bio-gases of the bottom ply. The UV stabilizers in the top ply are thereby protected against corrosion.

In yet another aspect of the present invention, the top and bottom plies contain polyethylene, for protecting the middle ply from weather conditions and from corrosive environments under the cover.

In yet a further aspect of the present invention, the membrane structure also comprises two foam layers affixed to the bottom ply. Each foam layer is made of juxtaposed strips of semi-rigid, closed-cell, polyethylene foam. Each strip in one foam layer is laid astride the edges of a pair of strips in the other foam layer.

Each foam layer has a thickness of about one-half inch such that a stiffness provided by these two layers prevents wind-induced fluttering in a membrane cover made with this structure.

This brief summary has been provided so that the nature of the invention may be understood quickly. A more complete understanding of the invention can be obtained by reference to the following detailed description of the preferred embodiment thereof in connection with the attached drawings.

### BRIEF DESCRIPTION OF THE DRAWINGS

The drawings illustrate a preferred structure of a membrane cover having protection against deterioration of the UV stabilizers therein. The drawings also illustrate a secondary inherent advantage of the improved membrane structure. In the accompanying drawings, like numerals denote like parts throughout the several views, and in which;

FIG. 1 illustrates a partial perspective view of a preferred membrane structure;

FIG. 2 is an enlarged, not-to-scale, transverse cross-section view of the preferred membrane structure;

FIG. 3 is an enlarged, transverse cross-section view through the top layer of a portion of the preferred membrane structure, as seen in detail circle 3 in FIG. 2;

FIG. 4 is a cross-section view of a reservoir having a prior art membrane cover laid thereon and illustrating a situation where the membrane cover is susceptible to ice damage;

FIG. 5 illustrates a similar view as in FIG. 4 with a membrane cover having a structure according to the preferred embodiment, illustrating a situation where ice damage to the cover is practically eliminated.

### DESCRIPTION OF THE PREFERRED EMBODIMENT

While this invention is susceptible of embodiment in many different forms, there is shown in the drawings and will be described in details herein one specific embodiment, with the understanding that the present disclosure is to be considered as an example of the principles of the invention and is not intended to limit the invention to the embodiment illustrated and described.

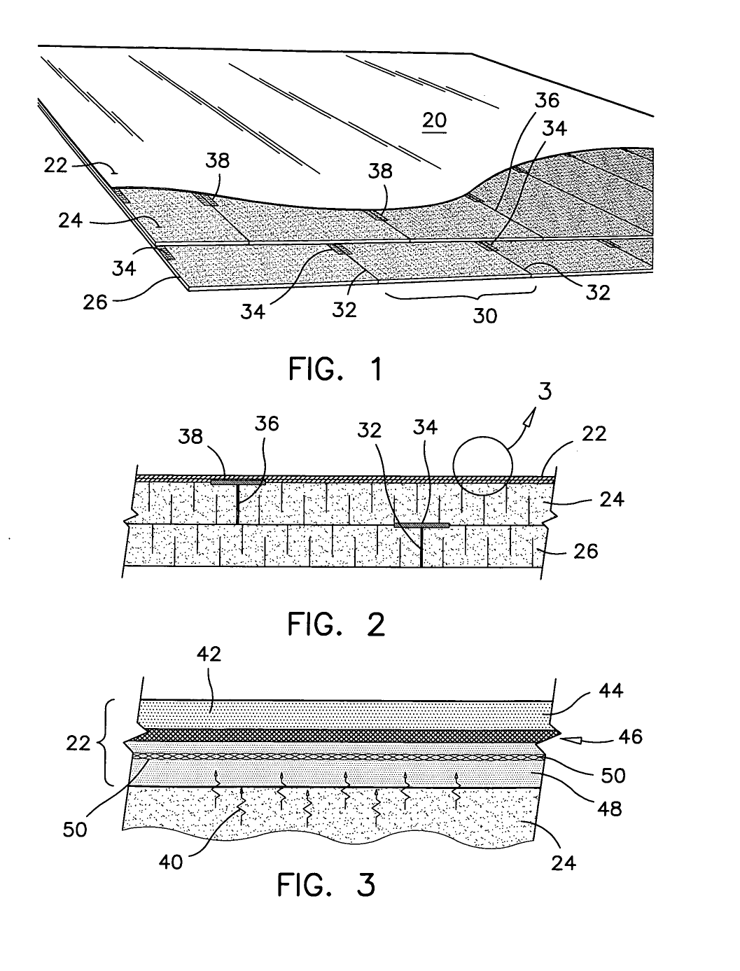

The preferred membrane structure 20 is partially illustrated in FIG. 1. The preferred membrane structure 20 is made of a top layer 22 bonded to two foam layers 24, 26. The foam layers 24, 26 are made of semi-rigid foam insulation. The top layer 22 is impermeable to water and gas and is resistant to ultraviolet radiations. The two foam layers 24, 26 are bonded together and to the top layer 22, as illustrated in FIGS. 1 and 2. The bonding of the three layers is effected by hot-melt welds.

One of the foam layers constitutes a bottom layer 26 and is intended to be in contact with the liquid surface inside a wastewater reservoir for example. The top layer 22 is preferably made of a stretch-resistant polyethylene-based pliable sheet material. Each of the foam layers 24, 26 is preferably made of semi-rigid, closed-cell, water-impermeable polyethylene insulating foam. Each foam layer 24, 26 preferably has a thickness of about one-half inch. The stiffness obtained in the membrane structure by such overall thickness, provides unexpected advantages as will be explained later, when a cover with the preferred membrane structure 20 is mounted over a large liquid reservoir.

The middle and bottom foam layers 24, 26 are made of juxtaposed strips 30 each having a width of about four to ten feet. The strips 30 in the middle layer 24 are laid astride the joints 32 in the bottom layer 26. The adjacent edges in each joint 32 in the bottom layer 26 are bonded to the undersurface of the middle layer 24 by hot-melt welds 34. Similarly, the adjacent edges in each joint 36 in the middle layer 24 are bonded to the undersurface of the top layer 22 by hot-melt welds 38. The hot-melt welds 34, 38 are localized welds in the form of continuous narrow strips of fused polyethylene overlapping the adjoining edges of each pair of juxtaposed strips 30.

Referring now to FIG. 3, the structure of the top layer 22 will be described in greater details.

In the preferred embodiment, the top layer 22 in the preferred membrane structure has three plies therein, one of which is a highly impermeable gas shield laid between the top and bottom plies, to reduce the migration of bio-gases 40 there through, and to prevent the deterioration of the UV stabilizers 42 therein.

In the preferred membrane structure 20, the top layer 22 has a top ply 44 which is made with a polyethylene-based material having UV stabilizers 42 embedded therein, in the form of metal oxides for example. The second ply 46 immediately beneath the top ply is made of a material that is highly impermeable to bio-gases such as a co-extruded polyvinylidene chloride (PVDC) barrier film, a metallic foil or a similar highly impervious material. This second ply 46 may also contain or may be coated with polyethylene. This second ply is bonded to the top ply 44. The third or bottom ply 48 is made primarily of polyethylene and contains a reinforcing scrim 50 or a high-strength fabric therein. The third ply 48 is bonded to the second ply 46 and to the middle foam layer 24.

The second ply 46 is also referred to herein as the bio-gas shield, and the third or bottom ply 48 is also referred to as the structural ply.

The structural ply 48 has an impermeability to bio-gas of a first extent, as in membrane materials known in the prior art, and the second ply 46 has an impermeability to bio-gases of a second extent. The second extent is greater than the first extent. Preferably, the second ply 46 is more impermeable to bio-gases than the structural ply 48 by at least 50%, and more preferably by a factor of two or more.

It is believed that the useful life of a membrane cover is directly proportional to its protection against UV radiations. Consequently, it is also believed that the useful life of a membrane cover made with the preferred structure 20 is increased by a same proportion as a ratio of the impermeability to bio-gases of the second and third plies 46, 48.

The polyethylene content in the top and bottom plies 44, 48 is advantageous for protecting the middle ply 46 from the weather conditions on a top side thereof and from the corrosive environment that may be present under the membrane cover. Furthermore, the top ply 44 is preferably made of a light-colored material so that it does not absorb heat from sunlight as much as a dark-colored membrane.

Although a three-ply membrane structure has been described herein, it should be understood that the scope of the present invention also encompasses a two-ply membrane structure wherein the bio-gas shield constitutes a bottom ply beneath a top ply having UV stabilizers therein. In this case, the impermeability to bio-gases of the top ply is taken as a reference representing the impermeability to bio-gases of prior art membrane structures. Accordingly, the bio-gas shield has an impermeability to bio-gases that is greater that the impermeability of the top ply. Similarly, the scope of the present invention should also includes the cases where the reinforcing scrim 50 is embedded in the either one of the top or the middle ply.

Aside from the aforesaid advantage of increasing the life of a membrane cover, it has been found that there are at least three additional inherent advantages of the preferred membrane structure 20. Firstly, it has been noted that, because of the stiffness of the three-layered membrane structure 20, the membrane cover made therewith is less vulnerable to wind uplift than a single ply membrane. Because the membrane is less vulnerable to wind uplift, the vacuum force to stabilize the membrane against wind uplift is only required to a lesser extent.

Secondly, it has been found that because of the increased stiffness in the membrane structure, less weight lines are required on the membrane cover to push the bio-gases to the perimeter of the reservoir.

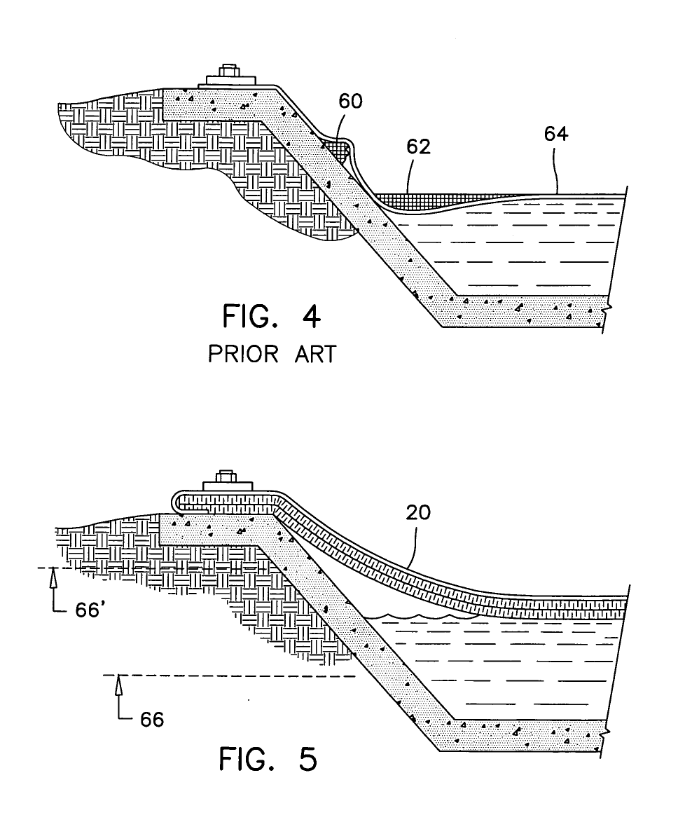

The third advantage is found in the use of this membrane structure 20 for covering wastewater or potable water reservoirs in cold-weather regions and wherein the level of liquid in the reservoir fluctuates with time. In order to better explain the advantage of the double-foam-layered arrangement in the preferred membrane structure 20, reference is made to a prior art installation as shown in FIG. 4. During winter, the water under the cover freezes along the edges of the reservoir, leaving ice buildups 60 on the interior wall of the reservoir. There are also ice buildups 62 over the membrane cover 64 from rain and snow accumulating along the edges of the cover. When the liquid level falls below the ice buildups 60 inside the reservoir, as illustrated, and rises again, the ice buildups 60, 62 interlock with each other and tear the membrane 64.

It has been found that the insulated membrane structure 20 of the preferred embodiment, with its two foam layers 24, 26 causes the frost line 66 inside and below the reservoir to rise to a new position 66′ above the water level inside the reservoir, thereby greatly reducing the problem of ice buildup under the cover.

While two foam layers 24, 26 have been described herein in the preferred membrane structure, it will be appreciated that a single foam layer may be all that is required in mild-weather regions or in low wind exposures, and three or more layers may be required in colder regions. Similarly, although a sloped-wall reservoir has been illustrated, a similar solution was obtained for similar problems with reservoirs having vertical walls.

While one preferred embodiment of the present invention has been illustrated and described herein above, it will be appreciated by those skilled in the art that various modifications, alternate constructions and equivalents may be employed without departing from the true spirit and scope of the invention. Therefore, the above description and the illustrations should not be construed as limiting the scope of the invention which is defined by the appended claims.

What is claimed is:

1. A method for extending the life of a floating membrane cover having UV stabilizers therein, and covering wastewater wherein bio-gases are formed, said method comprising the step of preventing a reaction of said bio-gases with said UV stabilizers by preventing infiltration of said bio-gases through said membrane cover.

2. The method as claimed in claim 1 wherein said step of preventing comprises the step of isolating said UV stabilizers from said bio-gases with a gas-impermeable sheet having a high degree of impermeability to said bio-gases, extending between said wastewater and said UV stabilizers.

3. The method as claimed in claim 1, wherein said step of preventing comprises the steps of placing a top layer in said membrane cover wherein said top layer has said UV stabilizers embedded therein, and placing a gas-impermeable sheet having a high degree of impermeability to said bio-gases between said wastewater and said top layer.
